(19) United States
(12) Patent Application Publication
(10) Pub. No.: US 2019/0018723 A1
(43) Pub. Date: Jan. 17, 2019

(54) AGGREGATING METRIC SCORES

(71) Applicant: EntIT Software LLC, Sunnyvale, CA (US)

(72) Inventors: Ron Maurer, Haifa (IL); Marina Lyan, Modiin (IL); Nurit Peres, Yehud (IL); Fernando Vizer, Yehud (IL); Pavel Danichev, Yehud (IL); Shahar Tel, Yehud (IL)

(21) Appl. No.: 15/647,049

(22) Filed: Jul. 11, 2017

(51) Int. Cl. G06F 11/07; G06F 11/34; G06F 17/18; G06F 17/40; G06K 9/00; G06K 9/62

(52) U.S. Cl. CPC G06F 11/07; G06F 11/3452; G06F 11/3476; G06F 17/18; G06F 3/04842; G06K 9/00543; G06K 9/6284; G06F 2201/86; G06F 17/40

(57) ABSTRACT

In some examples, host IDs associated with the respective source component and a result of a partial calculation of an aggregate metric score may be received from each of a plurality of source components associated with a host of an information technology (IT) system. The partial calculation based on individual metric scores may be associated with the respective source component. The aggregate metric score may be calculated using the partial calculations and the host IDs, the aggregate metric score associated with metric measurements of the source components.

### BACKGROUND

In some examples, data streams may be collected from hosts in computer systems. A host may be a computing device or other device in a computer system such as a network. The hosts may include source components, such as, for example, hardware and/or software components. These source components may include web services, enterprise applications, storage systems, databases, servers, etc.

### BRIEF DESCRIPTION

Some examples are described with respect to the following figures:

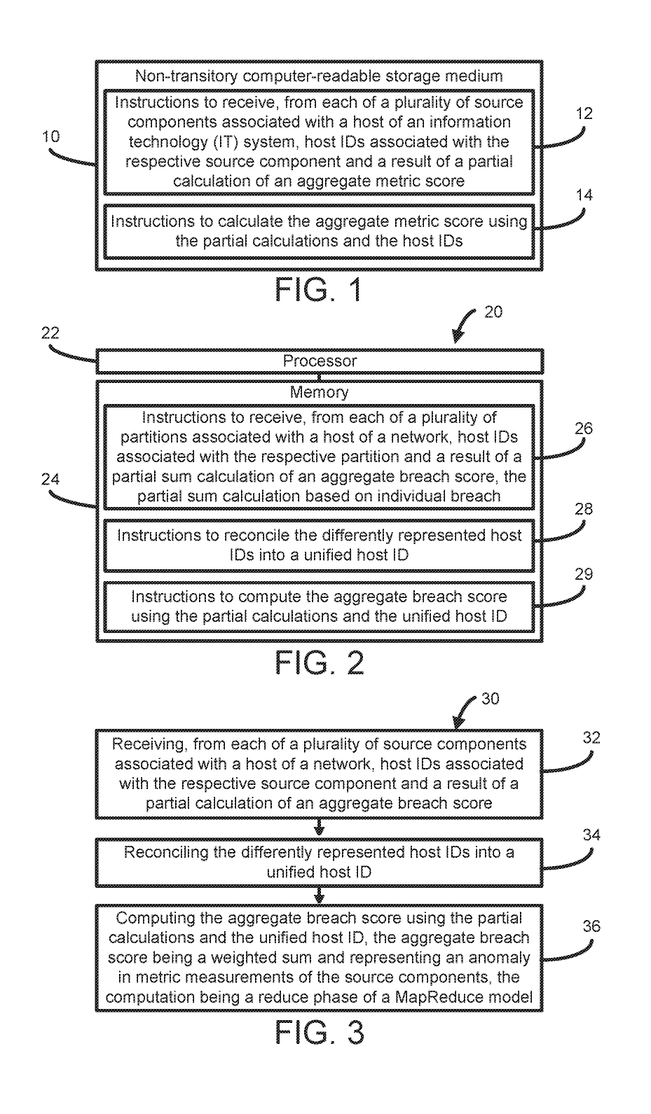

FIG. 1 is a block diagram illustrating a non-transitory computer readable storage medium according to some examples.

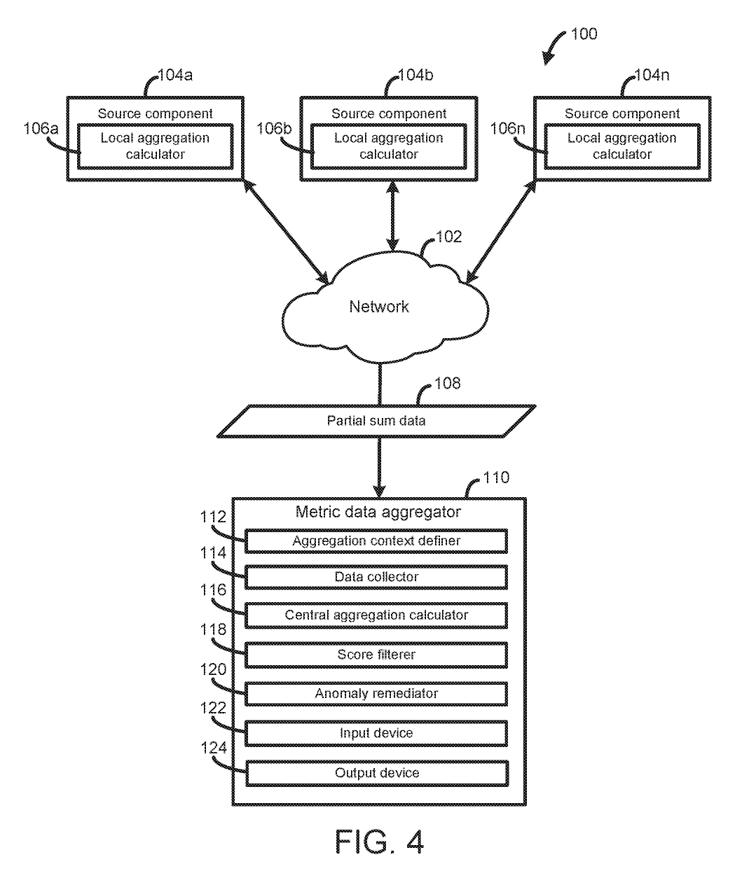

FIGS. 2 and 4 are block diagrams illustrating systems according to some examples.

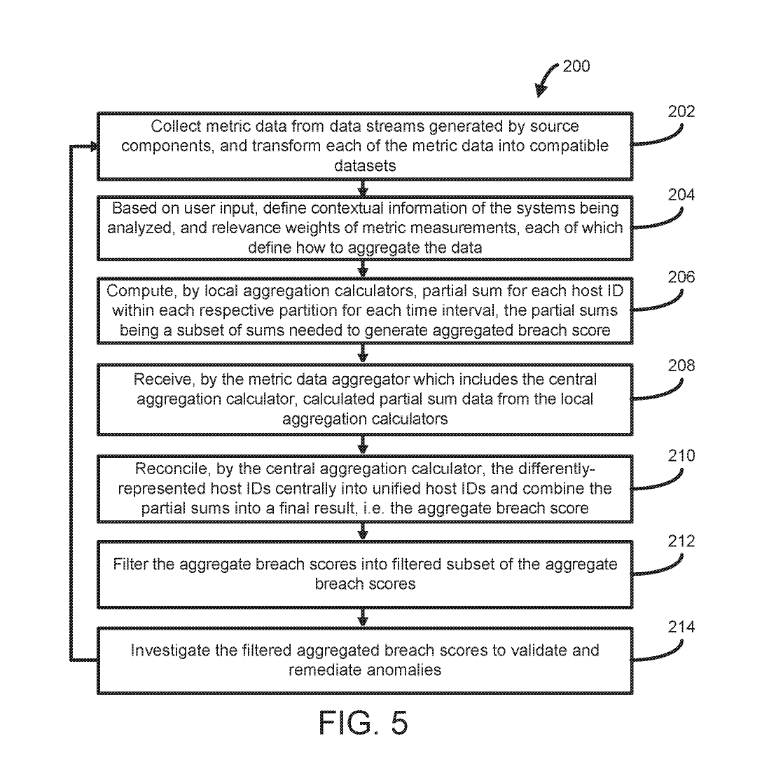

FIGS. 3 and 5 are flow diagrams illustrating methods according to some examples.

### DETAILED DESCRIPTION

The following terminology is understood to mean the following when recited by the specification or the claims. The singular forms “a,” “an,” and “the” mean “one or more.” The terms “including” and “having” are intended to have the same inclusive meaning as the term “comprising.”

Data streams such as log streams and metric streams may be collected from the hosts and their source components. The log streams and metric streams may include metric data, which may include various types of numerical data associated with the computing system. Metric streams may include metric data, but e.g. without additional textual messages. Log streams may include log messages such as textual messages, and may be stored in log files. These textual messages may include human-readable text, metric data, and/or other text. For example, the log messages may include a description of an event associated with the source component such as an error. This description may include text that is not variable relative to other similar messages representing similar events. However, at least part of the description in each log message may additionally include variable parameters such as, for example, varying numerical metrics.

In some examples, metric data may comprise computing metric data, such as central processing unit (CPU) usage of a computing device in an IT environment, memory usage of a computing device, or other type of metric data. In some examples, each of these metric data may be generated by, stored on, and collected from source components of a computer system such as a computer network. This metric data may store a large amount of information describing the behavior of systems. For example, systems may generate thousands or millions of pieces of data per second.

The metric data may be used in system development for debugging and understanding the behavior of a system. For example, breaches in the metric data, e.g. a value outside of a predetermined expected range of values, may be identified. Based on these breaches (e.g. if multiple breaches occur in a short period of time), it may be determined that there is an anomaly in the system as represented by an anomaly score, or the breach scores may directly be used as anomaly scores representing anomalies in the system.

After identification, each anomaly may be investigated by a user such as a subject matter expert to either discard the anomaly as not representing a system problem, or validate the anomaly as representing an actual system problem. When an anomaly is validated, actions may be taken, automatically or manually by the subject matter expert, in the IT environment in response to the validated anomaly. For example, automatic remedial and/or preventative measures may be taken.

However, the subject matter expert may be able to investigate a small number of anomalies (e.g., 10 per hour), whereas complex systems with millions of streams may include a high rate of identified anomalies. Additionally, accuracy of anomaly detection may be low when using single data streams to identify anomalies, and most anomaly analysis methods for such disparate data types are also disparate in nature with results that are hard to compare and integrate.

Therefore, anomaly identification may be enhanced by aggregating varied lower-level metric data (e.g. breaches, anomalies, and/or raw metric data) from varied source components and/or relating to multiple aspects of system behavior into higher-level metric data. For example, metric data from multiple source components of a single host may be aggregated. This may allow a subject matter expert to handle a smaller number of higher-level anomalies rather than a larger number of lower-level anomalies. Additionally, the accuracy of the aggregated data with respect to identifying actual anomalies may be higher than for lower-level alerts.

However, aggregation of the metric data may be challenging due to different data streams having different data types and different contexts in which different source components generate metric data. Thus, the data may need to be defined in comparable ways to allow aggregation. Additionally, the metric data may be distributed in the system, and therefore aggregation may involve an added step of, for each host, collecting information from different source components, such as different hardware and software partitions (e.g. of memory, disks, databases, etc.). This may make aggregation computationally expensive and time consuming, as a centralized system may be needed to collect the metric data before aggregation.

Accordingly, the present disclosure provides examples in which the metric data may be aggregated in a decentralized and computationally efficient and faster way. This may involve use of the MapReduce programming model, which allows for processing big data sets with a parallel, distributed algorithm.

FIG. 1 is a block diagram illustrating a non-transitory computer readable storage medium 10 according to some examples. The non-transitory computer readable storage medium 10 may include instructions 12 executable by a processor to receive, from each of a plurality of source components associated with a host of an information technology (IT) system, host IDs associated with the respective source component and a result of a partial calculation of an aggregate metric score, the partial calculation based on individual metric scores associated with the respective source component. The non-transitory computer readable storage medium 10 may include instructions 14 executable by a processor to calculate the aggregate metric score using the partial calculations and the host IDs, the aggregate metric score associated with metric measurements of the source components.

FIG. 2 is a block diagram illustrating a system 20 according to some examples. The system 20 may include a processor 22 and a memory 24. The memory 24 may include instructions 26 executable by the processor to receive, from each of a plurality of partitions associated with a host of a network, host IDs associated with the respective partition and a result of a partial sum calculation of an aggregate breach score, the partial sum calculation based on individual breach scores associated with the respective partition, the source components associated with the respective host being represented by different host IDs. The memory 24 may include instructions 27 executable by the processor to reconcile the differently represented host IDs into a unified host ID. The memory 24 may include instructions 28 executable by the processor to compute the aggregate breach score using the partial calculations and the unified host ID, the aggregate breach score being a weighted sum and representing an anomaly in metric measurements of the partitions.

FIG. 3 is a flow diagram illustrating a method 30 according to some examples. The following may be performed by a processor. The method 30 may include: at 32, receiving, from each of a plurality of source components associated with a host of a network, host IDs associated with the respective source component and a result of a partial calculation of an aggregate breach score, the partial calculation based on individual breach scores associated with the respective source component and being a map phase of a MapReduce model, the source components associated with the respective host being represented by different host IDs; at 34, reconciling the differently represented host IDs into a unified host ID; and at 36, computing the aggregate breach score using the partial calculations and the unified host ID, the aggregate breach score being a weighted sum and representing an anomaly in metric measurements of the source components, the computation being a reduce phase of a MapReduce model.

FIG. 4 is a block diagram illustrating a system 100 according to some examples. The system 100 includes a network 102, such as a local area network (LAN), wide area network (WAN), the Internet, or any other network. The system 100 may include multiple source components 104a-n in communication with the network 102. These source components 104a-n may be parts of host devices (i.e. hosts), such as mobile computing devices (e.g. smart phones and tablets), laptop computers, and desktop computers, servers, networking devices, storage devices. Other types of source components may also be in communication with the network 102. Each of the hosts may comprise at least one source component, e.g. multiple source components. Each source component 104a-n may be associated with a respective local aggregation calculator 106a-n. That is, each source component 104a-n may include a respective local aggregation calculator 106a-n or may be associated with a respective local aggregation calculator 106a-n elsewhere in the system.

The system 100 may include metric data aggregator 110. The metric data aggregator 110 may include an aggregation definer 112, data collector 114, central aggregation calculator 116, score filterer 118, and anomaly remediator 120.

The metric data aggregator 110 may support direct user interaction. For example, the metric data aggregator 110 may include user input devices 122, such as a keyboard, touchpad, buttons, keypad, dials, mouse, track-ball, card reader, or other input devices. Additionally, the metric data aggregator 110 may include output devices 124 such as a liquid crystal display (LCD), video monitor, touch screen display, a light-emitting diode (LED), or other output devices. The output devices 124 may be responsive to instructions to display a visualization including textual and/or graphical data, including representations of any data and information generated during any part of the processes described herein.

In some examples, components such as the local aggregation calculators 106a-n, aggregation definer 112, data collector 114, central aggregation calculator 116, score filterer 118, and anomaly remediator 120 may each be implemented as a computing system including a processor, a memory such as non-transitory computer readable medium coupled to the processor, and instructions such as software and/or firmware stored in the non-transitory computer-readable storage medium. The instructions may be executable by the processor to perform processes defined herein. In some examples, the components mentioned above may include hardware features to perform processes described herein, such as a logical circuit, application specific integrated circuit, etc. In some examples, multiple components may be implemented using the same computing system features or hardware.

The source components 104a-n may generate data streams including sets of metric data from various source components in a computer system such as the network 102. In some examples, large-scale data collection and storage of the metric data in the data streams may be performed online in real-time using an Apache Kafka cluster.

The data streams may include log message streams and metric streams, each of which may include metric data. In some examples, each piece of metric data may be associated with a source component ID (e.g. host ID) which may be collected along with the metric data. A source component ID (e.g. host ID) may represent a source component (e.g. host) from which the metric data was collected.

In some examples, before aggregation can occur, the data streams may be transformed into respective time-series of metric data that are compatible and comparable with each other, to allow further analysis and aggregation of the data. The transformation may be performed anywhere by the local aggregation calculators 106a-n, but in other examples may be performed by other parts of the system 100. Each piece of metric data may include a timestamp representing a time when the data (e.g. log message, or data in a table) was generated. Each time-series may represent dynamic behavior of at least one source component over predetermined time intervals (e.g. a piece of metric data every 5 minutes). Thus, magnitudes of metric data from different source components may be normalized against each other, and may be placed on a shared time series axis with the same intervals. The transformed metric data may be sent back to the Kafka cluster (which may in the data collector 114) periodically for fast future access. Each of the breach scores in the metric data may be stored with metadata encoding operational context (e.g. host name, event severity, functionality-area, etc.). An Apache Storm real-time distributed computation system may be used to cope with the heavy computational requirements of online modeling, anomaly scoring, and interpolation in the time-series data.

In some examples, this transformation may transform the data streams into respective time-series of metric data may be performed by various algorithms such as those described in U.S. patent application Ser. No. 15/325,847 titled “INTERACTIVE DETECTION OF SYSTEM ANOMALIES” and in U.S. patent application Ser. No. 15/438,477 titled “ANOMALY DETECTION”, each of which are hereby incorporated by reference herein in their entirety.

In some examples, the aggregation definer 112 may output information relating the transformed metric data to output devices 124. Aggregation may involve understanding contextual information of the systems being analyzed that define how to aggregate the data, such as context for functionality (CPU, disk, and memory usage), hardware entities (hosts and clusters), and software entities (applications and databases), etc. That is, a decision needs to be made on which metric data to aggregate with other metric data. In some examples, these may involve aggregating, for each host, metric measurements from multiple source components relating to the host. Therefore, the subject matter expert may view the information relating the transformed metric data on the output devices 124, and then configure the contextual information interactively, using the input devices 122. The inputted contextual information may be received by the aggregation definer 112 via the input devices 122. Additionally, the relevance weight of each metric measurement in metric data from each source component may be defined by the subject matter expert in a similar way using the aggregation definer 112. The relevance weights may define the weight given in the aggregation calculations to each metric measurement.

In some examples, the local aggregation calculators 106a-n and the central aggregation calculator 116 may together aggregate the transformed metric data. The calculators 106a-n and 116 may then aggregate the metric data using the defined contextual information and importance factors. In some examples, formula 1 as described below may be used to calculate aggregate metric scores (e.g. aggregate breach scores b̅_{h,p}(Tₙ) based on individual metric scores (e.g. individual breach scores \hat{b}_{h,p,m}(Tₙ), for each host h per property p at a given time interval Tₙ:

$${\overline{b}}_{h , p} ( {T}_{n} ) = \frac{\begin{matrix}{ɛ}_{b} + {Σ}_{{m}^{′} , m} {c}_{{m}^{′} , m} \cdot [ {r}_{{m}^{′}} ( {T}_{n} ) \cdot {I}_{h , {m}^{′}} ( {T}_{n} ) \cdot \\ {{\hat{b}}_{h , p , {m}^{′}} ( {T}_{n} ) \times {r}_{m} ( {T}_{n} ) \cdot {I}_{h , m} ( {T}_{n} ) \cdot {\hat{b}}_{h , p , m} ( {T}_{n} ) ]}^{0.5}\end{matrix}}{\begin{matrix}{ɛ}_{1} + {Σ}_{{m}^{′} , m} {c}_{{m}^{′} , m} \cdot [ {r}_{{m}^{′}} ( {T}_{n} ) \cdot \\ {{I}_{h , {m}^{′}} ( {T}_{n} ) \times {r}_{m} ( {T}_{n} ) \cdot {I}_{h , m} ( {T}_{n} ) ]}^{0.5}\end{matrix}} \qquad ( 1 )$$

The various variables and indices in formula 1 are defined as follows. A specific metric measurement in a set of metric data is represented by indices m or m′ and is associated with a host represented by indices h or h′. A metric measurement may be a numerical value associated with the function of a source component and/or associated with an event. For each combination of metric measurement m of property p associated with host h in time interval Tₙ, there may be an individual breach score \hat{b}_{h,p,m}(Tₙ). Time interval Tₙ is the nth time interval in a time-series. Property p may be a dynamic property of the host h, such as CPU, disk, or memory usage, or some other property.

Each aggregate breach score b̅_{h,p}(Tₙ) is based on a weighted average of breach score \hat{b}_{h,p,m}(Tₙ) products measuring simultaneous occurrence of breaches. In this example, the aggregate breach score b̅_{h,p}(Tₙ) aggregates different measurements m related to the same property p of the same host h, as may have been defined by the aggregation definer 118. However, in other examples, formula 1 may be modified such that an aggregate breach score may aggregate different measurements m related to multiple properties p of the same host h, aggregate different measurements m related to a single property p across multiple hosts h, aggregate different measurements m related to multiple properties p across multiple hosts h, or based on some other contextual information relating to aggregation.

Each measurement m may be associated with a relevance weight rₘ (independent of the host h or property p). In some examples, the relevance weights rₘ may be static. However, even in these examples, the relevance weights rₘ may change due to user feedback, as described earlier relative to the aggregation definer 112, so the relevance weights rₘ may also be considered as dependent on the time interval Tₙ.

Each measurement m may be associated with an information mass I_{h,m}(Tₙ) (independent of a property p). In some examples, I_{h,m}(Tₙ)=1 in each time interval Tₙ where the metric measurement m appeared at least once in host h (e.g. appeared at least once in a log stream from host h), regardless of the property p. Otherwise, I_{h,m}(Tₙ)=0.

In an example, the ε constants may be defined as ε₁=1 and ε_{b}=2⁻¹⁰, but may be changeable through user feedback from the subject matter expert via the input devices 122 to optimize for particular data streams.

The above computations of the aggregate breach scores b̅_{h,p}(Tₙ) and the information masses I_{h,m}(Tₙ) may be performed using metric data associated with different source components (e.g. different hardware and software partitions P such as memory, disks, databases, etc.) that are distributed across a system. The host IDs of hosts h may be expressed in different formats, such as by IP addresses or by host names.

As discussed earlier, performing the above computations using a central system after collecting the metric data from the hosts h may be computationally expensive and time consuming. For example, the computation of the numerator and denominator of formula 1 may involve sending a large number of information masses I_{h,m}(Tₙ) and individual breach scores \hat{b}_{h,p,m}(Tₙ) along with their host IDs to a central repository in the anomaly engine, and perform reconciliation and computation in that central system. This may incur a large input/output overhead. For example, if there are in the range of 10,000 hosts and 100 metric measurements active in each time interval Tₙ, then there may be about a million pairs of information masses I_{h,m}(Tₙ) and individual breach scores \hat{b}_{h,p,m}(Tₙ) (per property p) to transfer from the hosts h to the anomaly engine in each time interval Tₙ, to perform reconciliation, and to then perform the computations.

Therefore, computations of aggregate breach scores b̅_{h,p}(Tₙ) and the information masses I_{h,m}(Tₙ) associated with any single host h may be distributed between the different partitions P, as will be described. This may involve using a MapReduce model to achieve a more computationally efficient and faster calculation than using the central system described above.

First, it is noted that the numerator and denominator in the formula (1) have a similar algebraic form, expressed as Y=Σ_{m′,m}C_{m′,m}·x_{m′}·xₘ. In the numerator, xₘ=[rₘ(Tₙ)·I_{h,m}(Tₙ)·\hat{b}_{h,p,m}(Tₙ)]^{0.5}, and in the denominator, xₘ=[rₘ(Tₙ)·I_{h,m}(Tₙ)]^{0.5}. If C_{m′,m} is a constant C_{d} (i.e., independent of m), then the sum of products can be decoupled into a product of the sums Y=C_{d}Σ_{m′,m}·x_{m′}·xₘ=C_{d}(Σ_{m′}x_{m′})·(Σₘxₘ)=C_{d}(Σₘxₘ)². If the sum of the terms is denoted by X₁=Σₘxₘ, then the total expression is Y=C_{d}X₁². Since the coupling weights are different for the case of same event id C_{m′=m}=Cₛ, the above expression may be modified adding and subtracting S=ΣₘC_{m,m}·xₘ·xₘ=CₛΣₘxₘ²=Cₛ·X₂. The combined expression for the case with connection weights having a different value only along the diagonal is then:

Y=C_{d}X₁²+(Cₛ−C_{d})X₂ (2)

The difficulty in a distributed setting is a single partition P may not contain all of the representations of any single host h (e.g. IP address or host name) may not available. This may be because the partition may include only a part of a host, for example, a particular hardware or virtual device that is one among many devices of the host h. This information may become available later in a central system. Therefore, calculating the above two sums represented by Y in formula 2 cannot be performed in a single partition P.

Thus, the computation of the aggregate breach scores b̅_{h,p}(Tₙ) may be performed in two phases in accordance with the MapReduce model. In the “map” phase, the local aggregation calculators 106a-n may each compute a partial sum per host ID within each respective partition P (i.e. respective source component 104a-n). Therefore, the “map” phase of the calculation is performed in a distributed way across source components 104a-n. In the “reduce” phase, the central aggregation calculator 116 may reconcile the differently-represented host IDs centrally into unified host IDs and combine the partial sums into a final result, i.e. a calculation of the numerator, denominator, and the aggregate breach score b̅_{h,p}(Tₙ).

In the “map” phase, for each partition P, the following calculations of partial sums may be performed, by the local aggregation calculators 106a-n, for each of the host IDs that are represented in that partition P in time interval Tₙ. The calculation includes the following two partial sums for the numerator, for each property p:

X_{1P}(h,Tₙ,p)=Σ_{m∈h(T}_{ₙ}_{)@P}[rₘ(Tₙ)·I_{h,m}(Tₙ)·\hat{b}_{h,p,m}(Tₙ)]^{0.5} (3)

X_{2P}(h,Tₙ,p)=Σ_{m∈h(T}_{ₙ}_{)@P}rₘ(Tₙ)·I_{h,m}(Tₙ)·\hat{b}_{h,p,m}(Tₙ) (4)

And the calculation further includes the following partial sums for the denominator (just one set that is independent of property p):

X_{1P}(h,Tₙ,INFO_MASS)=Σ_{m∈h(T}_{ₙ}_{)@P}[rₘ(Tₙ)·I_{h,m}(Tₙ)]^{0.5} (5)

X_{2P}(h,Tₙ,INFO_MASS)=Σ_{m∈h(T}_{ₙ}_{)@P}rₘ(Tₙ)·I_{h,m}(Tₙ) (6)

For metric measurements just including a numerical value, the sums may run over each of the metric measurements m with non-zero information mass I_{h,m}(Tₙ) for host h in time interval Tₙ, as represented in partition P. For metric measurements having a numerical value associated with an event, the sum may run over each of the events that occurred at least once in host h in time interval Tₙ, as represented in partition P.

Each partition P (source component) may write its partial sums to a table with columns representing the time interval Tₙ, host ID, property p, and calculated partial sum values X_{1P} and X_{2P}. As mentioned earlier, property p may be a dynamic property of the host h, such as CPU, disk, or memory usage, or some other property. For metric measurements from metric streams, the property p values in the table may, in the numerator and denominator of formula 1, additionally be label to represent a “metric breach” or a “metric information mass”. For metric measurements from log streams, the property p type values in the table may, in the numerator of formula 1, additionally be labeled to represent a “log breach activity”, “log breach burst”, “log breach surprise”, and “log breach decrease” (different breach behaviors), and in the denominator of formula 1, represent a “log information mass”.

In some examples, the data collector 114 of the metric data aggregator 110 may receive the data in the tables, including the calculated partial sum data 108, from the local aggregation calculators 106a-n.

In the “reduce” phase, central aggregation calculator 116 may, using the data collected by the data collector 114, reconcile the differently represented host IDs for the same hosts to obtain unified host IDs. That is, before reconciliation, the host IDs may have had an x:1 mapping between the host IDs and hosts, where x is greater than 1, and after reconciliation there may be a 1:1 mapping between unified host IDs and hosts. Then, the central aggregation calculator 116 may group the partial sums by unified host ID, time interval Tₙ, and property p, and compute the full sums of for X₁(H, Tₙ, p) and X₂(H, Tₙ, p):

X₁(H,Tₙ,p)=Σ_{h(P)∈H}X_{1P}(h,Tₙ,p) (7)

X₂(H,Tₙ,p)=Σ_{h(P)∈H}X_{2P}(h,Tₙ,p) (8)

Then, the central aggregation calculator 116 may compute the numerators and denominators for each host h properties p using the formula 2, namely Y=C_{d}X₁²+(Cₛ−C_{d})X₂, and then compute the total breach score using:

$${\overline{b}}_{h , p} ( {T}_{n} ) = \frac{{ɛ}_{b} + Y \{ Numerator \}}{{ɛ}_{1} + Y \{ Denominator \}} \qquad ( 9 )$$

In some examples, score filterer 118 may then filter the aggregate breach scores b̅_{h,p}(Tₙ) into filtered subset of the aggregate breach scores b̅_{h,p}(Tₙ). The subset may include scores that exceed a threshold. In some examples, an aggregate breach score b̅_{h,p} (Tₙ) may be filtered out (i.e. not included in the subset) if B̅_{h,p}(Tₙ)=0 when that b̅_{h,p} (Tₙ) is input into formula 2:

B̅_{h,p}(Tₙ)=max[0,log₂((εₗ/ε_{b})·b̅_{h,p}(Tₙ))] (10)

Thus, the filtered aggregate breach score b̅_{h,p}(Tₙ) may represent an anomaly in metric measurements of source components 104a-n in the information technology (IT) system. In some examples, the filtered aggregated breach scores b̅_{h,p}(Tₙ) may be investigated by a user such as a subject matter expert to either discard the anomaly as not representing a system problem, or validate the anomaly as representing an actual system problem to the anomaly remediator 120 via the input devices 122. When an anomaly is validated, actions may be taken, automatically or manually by the subject matter expert, in the IT environment in response to the validated anomaly using the anomaly remediator 120 via the input devices 122. For example, automatic remedial and/or preventative measures may be taken.

FIG. 5 is a flow diagram illustrating a method 200 according to some examples. In some examples, the orderings shown may be varied, some elements may occur simultaneously, some elements may be added, and some elements may be omitted. In describing FIG. 5, reference will be made to elements described in FIG. 4. In examples, any of the elements described earlier relative to FIG. 4 may be implemented in the process shown in and described relative to FIG. 5.

At 202, the source components 104a-n may generate data streams including sets of metric data from various source components in a computer system such as the network 102, and the data streams may be transformed into respective time-series of metric data that are compatible and comparable with each other, to allow further analysis and aggregation of the data. Any processes previously described earlier relative to FIG. 4 and related to the above process may be implemented as implemented by the host identifier 114 may be implemented at 202.

At 204, the aggregation definer 112 may, based on user input, define contextual information of the systems being analyzed, and relevance weights of metric measurements, each of which define how to aggregate the data. This may be done on an ongoing basis throughout the method 200. Any processes previously described as implemented by the aggregation definer 112 may be implemented at 204.

At 206, in a “map” phase of the MapReduce model, the local aggregation calculators 106a-n may each compute a partial sum for each host ID within each respective partition P (i.e. respective source component 104a-n) for each time interval Tₙ. These partial sums may be a subset of the sums needed to be calculated to generate an aggregated breach score. Any processes previously described as implemented by the local aggregation calculators 106a-n may be implemented at 206.

At 208, the data collector 114 of the metric data aggregator 110 may receive data, including the calculated partial sum data 108, from the local aggregation calculators 106a-n. Any processes previously described as implemented by the data collector 114 may be implemented at 208.

At 210, in a “reduce” phase of the MapReduce model, the central aggregation calculator 116 may, using the data collected by the data collector 114, reconcile the differently-represented host IDs centrally into unified host IDs and combine the partial sums into a final result, i.e. a calculation of the aggregate breach score. Any processes previously described as implemented by the central aggregation calculator 116 may be implemented at 210.

At 212, the score filterer 118 may then filter the aggregate breach scores into filtered subset of the aggregate breach scores. The subset may include scores that exceed a threshold. Any processes previously described as implemented by the score filterer 118 may be implemented at 212.

At 214, the filtered aggregated breach scores may be investigated by a user to either discard the anomaly as not representing a system problem, or validate the anomaly as representing an actual system problem to the anomaly remediator 120 via the input devices 122. When an anomaly is validated, actions may be taken, automatically or manually by the subject matter expert, in the IT environment in response to the validated anomaly using the anomaly remediator 120 via the input devices 122. Any processes previously described as implemented by the anomaly remediator 120 may be implemented at 214. The method 200 may then return to 202 to repeat the process.

Any of the processors discussed herein may comprise a microprocessor, a microcontroller, a programmable gate array, an application specific integrated circuit (ASIC), a computer processor, or the like. Any of the processors may, for example, include multiple cores on a chip, multiple cores across multiple chips, multiple cores across multiple devices, or combinations thereof. In some examples, any of the processors may include at least one integrated circuit (IC), other control logic, other electronic circuits, or combinations thereof. Any of the non-transitory computer-readable storage media described herein may include a single medium or multiple media. The non-transitory computer readable storage medium may comprise any electronic, magnetic, optical, or other physical storage device. For example, the non-transitory computer-readable storage medium may include, for example, random access memory (RAM), static memory, read only memory, an electrically erasable programmable read-only memory (EEPROM), a hard drive, an optical drive, a storage drive, a CD, a DVD, or the like.

All of the features disclosed in this specification (including any accompanying claims, abstract and drawings), and/or all of the elements of any method or process so disclosed, may be combined in any combination, except combinations where at least some of such features and/or elements are mutually exclusive.

In the foregoing description, numerous details are set forth to provide an understanding of the subject matter disclosed herein. However, examples may be practiced without some or all of these details. Other examples may include modifications and variations from the details discussed above. It is intended that the appended claims cover such modifications and variations.

1. A non-transitory computer-readable storage medium comprising instructions executable by a processor to:
receive, from each of a plurality of source components associated with a host of an information technology (IT) system, host IDs associated with the respective source component and a result of a partial calculation of an aggregate metric score, the partial calculation based on individual metric scores associated with the respective source component; and
calculate the aggregate metric score using the partial calculations and the host IDs, the aggregate metric score associated with metric measurements of the source components.

2. The non-transitory computer-readable storage medium of claim 1 wherein sets of metric data from data streams are to be collected and transformed into compatible time-series datasets.

3. The non-transitory computer-readable storage medium of claim 1 wherein
the source components associated with the host are represented by different host IDs, and
further comprising instructions executable by the processor to, before calculating the aggregate metric score, reconciling the differently represented host IDs into a unified host ID, and
wherein to calculate the aggregate metric score using the host IDs comprises to calculate the aggregate metric score using the unified host ID.

4. The non-transitory computer-readable storage medium of claim 1 wherein the partial calculation is based on contextual information of the IT system defining how to aggregate the individual metric scores into the aggregate metric score.

5. The non-transitory computer-readable storage medium of claim 4 wherein the contextual information defines which of the metric scores are to be aggregated when computing the aggregate metric score.

6. The non-transitory computer-readable storage medium of claim 4 wherein the contextual information defines relevance weights of the metric measurements to be used in the partial calculations.

7. The non-transitory computer-readable storage medium of claim 1 wherein the individual metric scores are individual breach scores and the aggregate metric score is an aggregate breach score, wherein the aggregate breach score represents an anomaly associated with the metric measurements of the source components.

8. The non-transitory computer-readable storage medium of claim 7 further comprising instructions executable by the processor to remediate the anomaly represented by the aggregate breach score.

9. The non-transitory computer-readable storage medium of claim 1 wherein the partial calculation and the calculation of the aggregate metric score involve calculating a weighted sum of individual metric scores, wherein the result of the partial calculation is a partial sum.

10. The non-transitory computer-readable storage medium of claim 1 further comprising instructions executable by the processor to determine whether to filter the calculated aggregate metric score from a set of aggregated metric scores based on whether the calculated aggregate metric score exceeds a threshold.

11. A system comprising:
a processor; and
a memory comprising instructions executable by the processor to:
receive, from each of a plurality of partitions associated with a host of a network, host IDs associated with the respective partition and a result of a partial sum calculation of an aggregate breach score, the partial sum calculation based on individual breach scores associated with the respective partition, the source components associated with the respective host being represented by different host IDs;
reconcile the differently represented host IDs into a unified host ID; and
compute the aggregate breach score using the partial calculations and the unified host ID, the aggregate breach score being a weighted sum and representing an anomaly in metric measurements of the partitions.

12. The system of claim 11 wherein sets of metric data from data streams are to be collected and transformed into compatible time-series datasets.

13. The system of claim 11 wherein the memory comprises instructions executable by the processor to receive user input of contextual information of the IT system defining which of the metric scores are to be aggregated when calculating the aggregate metric score.

14. The system of claim 11 wherein the memory comprises instructions executable by the processor to receive user input of contextual information of the IT system defining relevance weights of the metric measurements to be used in the partial sum calculations.

15. The system of claim 11 wherein the memory comprises instructions executable by the processor to remediate the anomaly represented by the aggregate breach score.

16. The system of claim 11 wherein the memory comprises instructions executable by the processor to determine whether to filter the calculated aggregate breach score from a set of aggregated breach scores based on whether the calculated aggregate breach score exceeds a threshold.

17. A method comprising:
by a processor:
receiving, from each of a plurality of source components associated with a host of a network, host IDs associated with the respective source component and a result of a partial calculation of an aggregate breach score, the partial calculation based on individual breach scores associated with the respective source component and being a map phase of a MapReduce model, the source components associated with the respective host being represented by different host IDs;
reconciling the differently represented host IDs into a unified host ID; and
computing the aggregate breach score using the partial calculations and the unified host ID, the aggregate breach score being a weighted sum and representing an anomaly in metric measurements of the source components, the computation being a reduce phase of a MapReduce model.

18. The method of claim 17 wherein the partial calculation is based on contextual information of the IT system defining which of the metric scores are to be aggregated when computing the aggregate metric score and defining relevance weights of the metric measurements to be used in the partial calculations.

19. The method of claim 17 further comprising determining whether to filter the aggregate breach score from a set of aggregated breach scores based on whether the aggregate breach score exceeds a threshold.

20. The method of claim 17 wherein sets of metric data from data streams are to be collected and transformed into compatible time-series datasets.
